(19) United States
(12) Patent Application Publication
(10) Pub. No.: US 2005/0226665 A1
(43) Pub. Date: Oct. 13, 2005

(54) System, apparatus and method for wide format printing

(76) Inventors: Uri Adler, Holon (IL); Yosef Kamir, Netanya (IL); Serge Steinblatt, Ra'anana (IL)

Correspondence Address: Simon Kahn;c/o LandonLP, Inc., 1700 Diagonal Road, Suite 450, Alexandria, VA, 22314-2866, US

(21) Appl. No.: 10/816,847

(22) Filed: Apr. 5, 2004

(51) Int. Cl. B41J 3/42

(52) U.S. Cl. 400/71

(57) ABSTRACT

A wide format printing system, apparatus and method are provided to enable standard printing units to print images in a selected wide format. In some embodiments the printing system includes a printing controller, image recognition unit, and a wide format printing apparatus including a plurality of printing sub-units being positioned to precisely cover the width of a substrate of selected size.

### FIELD OF THE INVENTION

The present invention relates generally to the field of printing and more specifically to a method and system for wide format printing.

### BACKGROUND OF THE INVENTION

The availability of printing engines and equipment for devices producing quality composite color images is typically limited to a width of approximately 300 mm. For example, one category of electrophotographic printing devices uses a laser-scanning device for the imaging of photoconductive drums (such as OPC drums). These laser-scanning devices are commonly available up to 300 mm of scanning width. Even if larger widths are possible to produce, the cost of widths above 300 mm may be very significant, as they may need to be custom made. Furthermore, the physical size of the laser scanning devices is required to increase with the scanning width. For 1200 mm of scanning width, for example, the size of the scanning device may be prohibitive for many printing devices.

Another category of electrophotographic printing devices use LED bars for the imaging of an OPC drum. The quality of the LED array, and in particular the homogeneity in size and power of the imaging light spots produced by the LED array, may play a critical role in the quality of the imaging quality. Typically, LED arrays for quality composite color applications are available in widths up to 300 mm. The production difficulties and costs associated with producing wider LED arrays, for example 1200 mm arrays, may be very significant.

It would be highly advantageous to have an improved method and apparatus for enabling wide format printing for quality composite color applications.

### SUMMARY OF THE INVENTION

According to some embodiments of the present invention, an apparatus and method are provided for producing wide format printing for quality composite color applications. The printing apparatus, device or system according to some embodiments of the present invention may include an array (plurality) of printing sub-units (subsystems, which may be being standard off the shelf independent printing devices or any other suitable printing units) of narrower width than the width of the wide format printer apparatus. A plurality of sub-units may be placed in, for example, a staggered configuration, the resulting juxtaposition of the sub-units combining to form a main printing device able to print wide format images. For example, in order to construct an electrophotographic printing system that can enable printing on 1200 mm advertising boards, for example, four 300 mm widths may be combined together to form a device with a printing width of 1200 mm. Any other sizes and/or numbers of printing sub-units may be used.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic illustration of a typical electrophotographic color printing device;

FIG. 2 is a schematic illustration of a wide format printing system, according to some embodiments of the present invention;

FIG. 3 is a schematic illustration of a configuration of printing sub-units in a wide format printing system, according to some embodiments of the present invention;

FIGS. 4A, 4B and 4C are schematic illustrations of results following fine tuning procedures of the sub-units in a wide format printing system, according to some embodiments of the present invention;

FIG. 5 is a schematic illustration of the results of a further fine tuning procedure of the sub-units in a wide format printing system, according to some embodiments of the present invention; and

FIG. 6 is a flow chart illustrating a method of configuring a wide format printing system, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

In the following detailed description, numerous specific details are set forth in order to provide a thorough understanding of the present invention. However, it will be understood by those skilled in the art that the present invention may be practiced without these specific details. In other instances, well-known methods, procedures and components have not been described in detail so as not to obscure the present invention.

The word “electrophotographic” as used hereinafter may encompass all laser and LED based printing methods, including electrophotographic, xerographic and ionographic etc. The words “wide format” as used hereinafter may refer to wide printing mechanisms, printer unit sizes, scanning devices, charging devices, toner devices, substrates, image formats, page sizes, form factors etc. For example, whereas typical laser printing mechanisms may have a width of up to 300 mm, embodiments of the present invention may be used to construct laser printing mechanisms with unlimited widths, for example, for billboards which may have a width of, for example, approximately 1200 mm. Any other suitable printer mechanism widths may likewise be provided, according to embodiments of the present invention, whether wide or non-wide (such as less than 300 mm, for example).

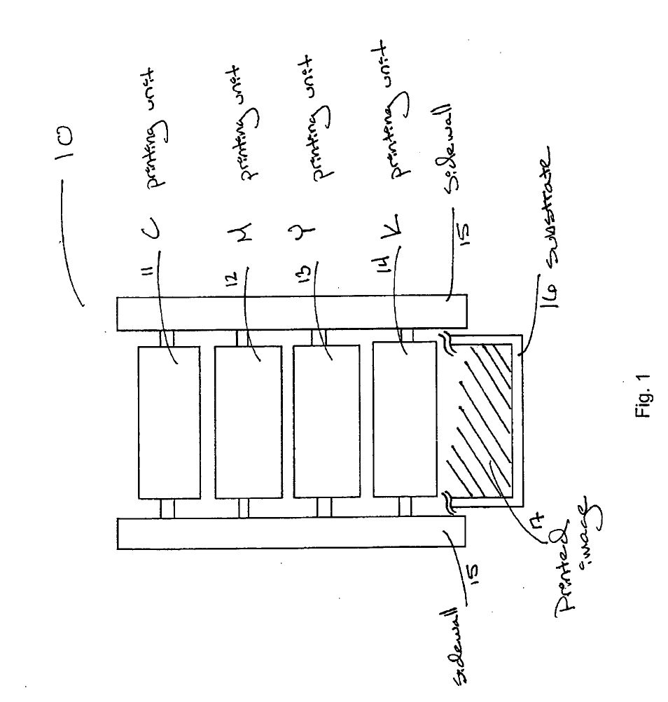

Reference is now made to FIG. 1, which is a block diagram illustration of a typical electrophotographic color printing apparatus 10. As can be seen in the figure, a typical color printing apparatus 10 may have several individual printing units for printing out primary colors—for example Cyan (C) 11, Magenta (M) 12, Yellow (Y) 13 and Black (K) 14. The CMYK printing units are generally mounted between sidewalls 15, within which the printing device elements are contained. These sidewalls 15 typically make the printing device 10 wider than the printing units (11-14). For example, if the printing device 10 is able to print 300 mm wide images, the sidewalls 15 may add several centimeters to the device width. Substrate 16, which is the target for the printed images typically passes under the various printing units, such that the printed image 17 is printed on substrate 16. Image 17 printed on substrate 16 is typically narrower than the device 10 physical width, due to the presence of sidewalls 15.

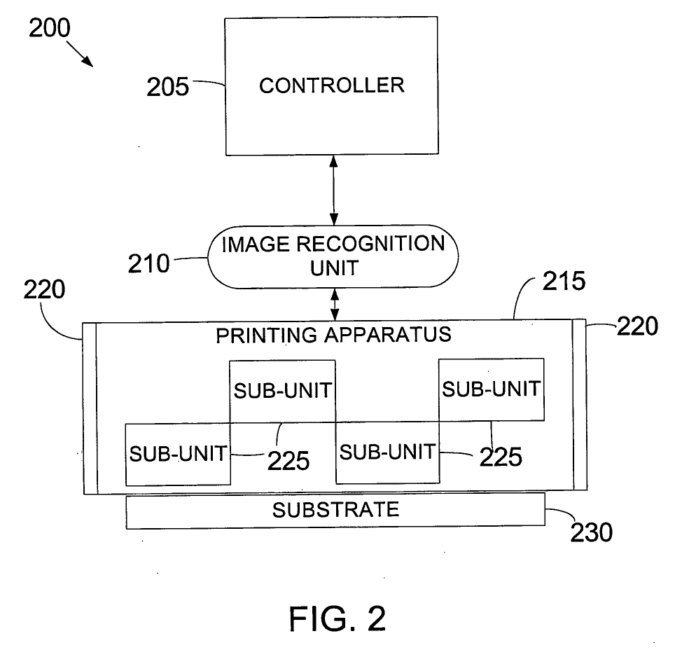

According to some embodiments of the present invention, a system, apparatus and method are provided for producing wide format printing, in particular to enable printing of quality composite color applications. The printing apparatus 200, as can be seen with reference to FIG. 2, according to some embodiments of the present invention, may include a printer controller 205, a printing recognition unit 210, and a printing apparatus 215. Printing controller 205 may include printing application software to manage and execute printing operations. Printing controller 205 may include image analysis code, to analyze printed images and provide commands for optimizing printing operations. Printing controller 205 may further enable, for example, tuning of the printing sub-units, and adjusting the color output etc. Printing recognition unit 210 may include image recognition devices, illumination devices, etc., to enable recognition of printed images. For example, a colorimeter may be included to enable color analysis, for example to match the colors at various positions in the printed image. Printing recognition unit 210 may include a pattern recognition system based on a CCD or CMOS camera, or other suitable recognition systems, and one or more suitable image processing algorithms, to, for example, view and analyze printed patterns. These or other suitable hardware and/or software components may enable the position of subunits within the printing apparatus 215 to be suitably adjusted according to the need. Printing recognition unit 210 may enable transmission of image recognition data to printer controller 205.

Printing apparatus 220 may include an array or plurality of printing sub-units 225 or subsystems, for example, electrophotographic printing sub-units, to print on a wide format substrate 230. These sub-units 225 may be standard off the shelf independent printing devices or any other suitable printing units, which may be of narrower width than the width of the wide format printer system. Printing sub-units 225 may include one or more toner cartridges, optionally for printing in a plurality of colors. A plurality of sub-units may be placed in, for example, a staggered configuration within sidewalls 220, or other suitable structures, of a wide format printing system, the resulting juxtaposition of the sub-units 225 combining to form a single printing device adapted to print images with a wide format, for example, with a width above 300 mm. Furthermore, the sub-units may be placed in such a way as to achieve seamless stitching between the sub-units 225. For example, in order to construct an electrophotographic printing system that can enable printing on 1200 mm advertising boards, for example, four separate printing devices of 300 mm width each may be combined together to form a printing system with a printing width of 1200 mm. Any other sizes and/or numbers of printing sub-units may be used.

When combining a plurality of printing sub-units to form a wide format printing system, printer controller 205 may coordinate the printing commands such that each sub-unit 225 prints only a portion of the whole printing task. For example, controller 205 may coordinate each of the sub-units 225 to start printing at a particular time relative to the other sub-units 225, such that the various portions of a printed image are printed out in their correct orders on the substrate so as to form one unified image.

It may furtermore be important to achieve mechanical accuracy of the placement of adjacent sub-units, as well as color matching of adjacent units. The mechanical accuracy of the placement of adjacent sub-units may be important to provide a correct pixel registration between adjacent sub-units. According to some embodiments of the present invention, the stitching region between the various printing units may be slightly overlapped. According to other embodiments of the present the sub-units may be placed without an overlap. The mechanical positioning of the sub-units, as well as synchronization of the imaging may be tuned so as to place the images printed by each of the sub-units at precisely the desired position on the substrate. Additionally, adjacent printing units may require color matching, since even slight coloring differences between adjacent sub-units 225 may indicate a difference between sub-units 225.

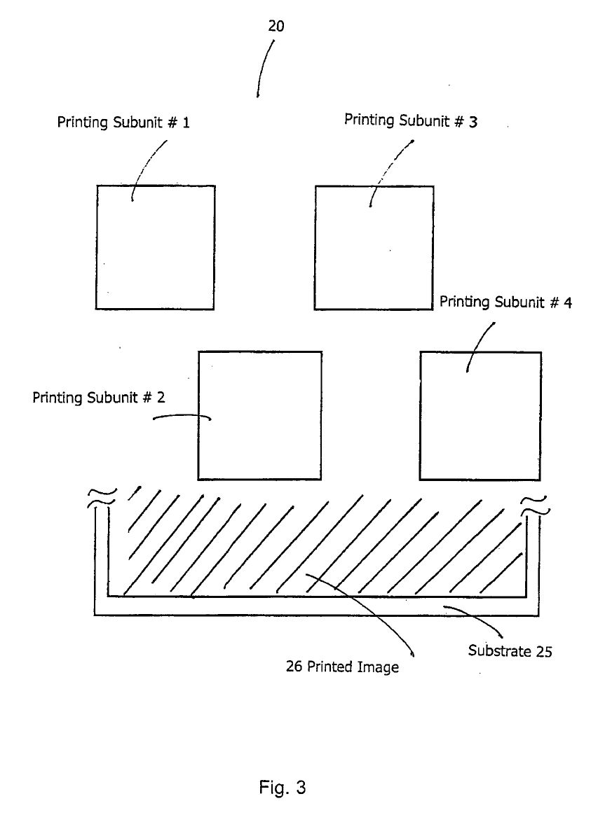

Reference is now made to FIG. 3, which is a schematic illustration of a configuration of printing sub-units (e.g., standard off the shelf units or sub-systems) so as to form a wide format printing system, according to some embodiments of the present invention. Each of these sub-units may include, for example, typical electrophotographic printer elements, for example, the corona for the charging of an OPC drum, an OPC drum, an imaging unit, a developer unit, a conditioning corona and an OPC cleaning unit. Each sub-unit may print in one or more colors (e.g., CMYK), as is known in the art. Various types of printing units may be used as print sub-units. In some embodiments of the present invention non-color or monochrome (e.g., black and white) printing systems may be so combined to produce a suitable non-color or monochrome printing system.

As can be seen in FIG. 3, the printing sub-units 21-24 may be placed in a staggered configuration, for example, or any other suitable configuration that may enable filling of a required printing area by the combination of the printing sub-units. In some embodiments an overlap may be formed between the sub-units, to enable the actual printing areas of the respective sub-units to be precisely aligned. Additionally or alternatively, the overlap may be owing to a slight overlap of the printing area of each of the sub-units. As can be seen in FIG. 3, printing sub-units 1-4 are typically not placed in a row, or next to each other in a contiguous fashion, as the sidewalls 15 may prevent such an alignment. For example, sub-units may be placed in a way such that a certain number (e.g. two) sub-units (for example, 2, 4) are in a forward position, and a certain number (e.g. two) sub-units (for example, 1, 3) are in a backward position. In this way all (four) sub-units 1-4 may print an image that is a portion of the whole image to be printed, at typically different times (forward and backward units printing at different intervals etc.). The configuration described above, or other suitable configurations of sub-units, may facilitate printing of a contiguous image 26 on, for example, a wide substrate 25. Other configurations using any suitable number or type of sub-units may be implemented.

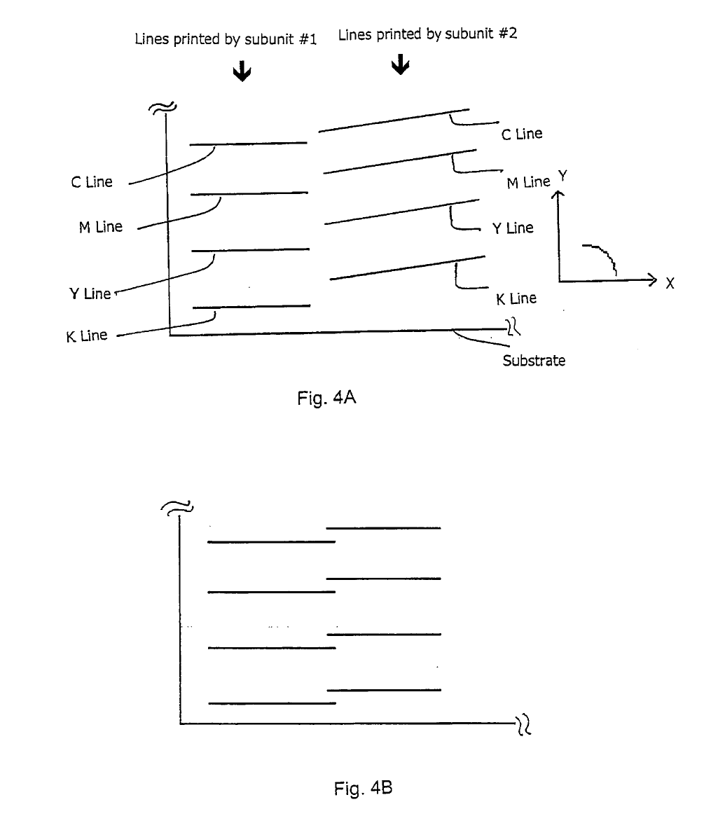

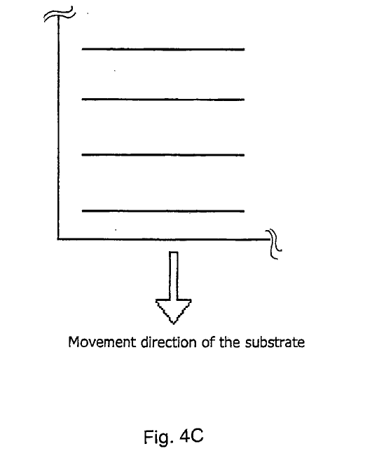

In some embodiments of the present invention it may be important to tune the adjacent sub-units in order to generate, for example, seamless wide format printing. The mechanical tuning of adjacent sub-units, for example using four-color printing units 1-4, may include printing a sequence of four lines, for example, across two adjacent sub-units, each one using one or more colors for printing. Various color systems may be used. In cases where the adjacent sub-units are not optimally aligned (e.g., before mechanical tuning), the lines may be, for example, in the position indicated by FIG. 4A. To correct this situation, the sub-units may need to be moved with respect to one another, in, for example, rotation (θ) and/or in translation (X). The tuning may require one or more repeated sequences of printing and mechanical tuning (θ,X) until the lines printed by the sub-units are parallel to each other, and at the correct spacing, according to the substrate width, as can be seen in FIG. 4B. A selected target for the adjustment accuracy may be, for example, ⅓ of a pixel in translation accuracy (along X) and 2 milliradians (mrad) in angular accuracy (along θ). Any other suitable accuracy targets may be used.

Following the mechanical adjustment, in cases where there is an offset (along Y) between the lines printed by the adjacent sub-units, a delay may be applied electronically or otherwise to the data transmission of at least one of the sub-units (in the case of the Fig.4B relative to one or more other sub-units. For example, as can be seen with reference to FIG. 4C, if the substrate moves in the direction indicated by the arrow, the delay applied to the data transmission of sub-unit #1 may be tuned in a repeated sequence of printing and delay tuning, until the lines of adjacent sub-units are substantially aligned. According to some embodiments of the present invention, the delay may be determined according to line numbers, for example, instructing sub-unit 21 to start printing at x lines after printing sub-unit 22 has completed printing a line. Other delay methods or units may be used. Delay adjustments may be implemented manually and/or automatically. An example of a typical target for the adjustment accuracy may be ⅓ of a pixel in translation accuracy (along Y). Other accuracy targets may be used. The delay in the data transmission may be such to substantially compensate for the full offset between the adjacent sub-units. Additionally or alternatively, modified data files may be produced for transmitting, for example, “zero” data lines for at least part (e.g., most) of the delay, down to, for example, a few pixels, after which the rest of the delay may be tuned electronically with, for example, a sub-pixel resolution. The last few pixels of correction may also be performed, for example, by mechanical adjustment of the sub-unit along Y. Other delay criteria or mechanisms may be used.

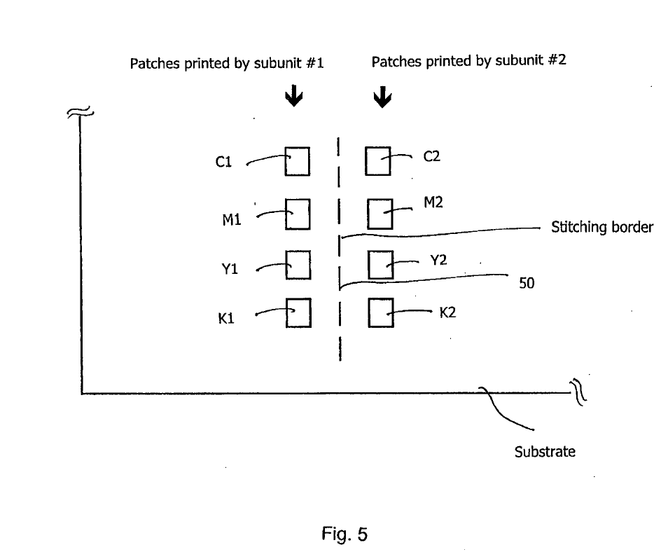

In cases where the colors of images printed by separate printing units may differ slightly, the color of adjacent sub-units may also be adjusted to provide contiguous images with minimal, negligible, or no noticeable color differences between segments. According to some embodiments of the present invention, color samples (e.g., patches or other images) may be printed by two or more sub-units (e.g., adjacent sub-units in the vicinity of the stitching border), as depicted in FIG. 5. For example, C1, M1, Y1 and K1 may be samples printed by sub-unit 1, and C2, M2, Y2 and K2 may be samples printed by sub-unit 2. The respective samples may be printed adjacent or substantially close to stitching border 50. For example, samples at 80% of solid color of each of the CMYK colors may be printed. The colors of the various samples may subsequently be measured using a colorimeter or any other suitable means. In the case where the color of at least one printer sub-unit needs adjusting, for example, the printer sub-unit may be adjusted by use of color management software tools, by tuning its developer voltage, and/or other means which may performed in typical printing devices. The color management tool and/or tuning of the developer voltage, for example, may be implemented automatically and/or manually. The color of the sub-units may be tuned to the desired value by a repeated sequence of printing and color tuning, for one or more of the CMYK colors. An example of a target for the color adjustment accuracy may be 0.5% for 80% solid color. Any other suitable accuracy target may be utilized, and other suitable sequences may be used. The adjustment procedure described above, or any other suitable adjustment process, may be applied at each of the stitching borders.

According to some embodiments of the present invention, each of the above processes for printing and/or tuning may include printing at several settings of the parameter of interest (e.g., X, Y, θ, color), and then choosing the optimal setting for the adjustment. This embodiment may enable further time and resource savings.

According to some embodiments of the present invention, a colorimeter that may be used may be external to the wide format printing system. An external calorimeter, for example, may be used for a one-time adjustment. Alternatively the colorimeter may be integrated into the printing system for repeated automatic adjustment, either periodically or before each printing sequence.

According to some embodiments of the present invention, a wide format electrophotographic printing system based on an array of electrophotographic sub-units may be used for printing wide format images that are erasable and/or those that are not erasable. For example, such a wide format printing system may be used for display systems and/or devices, such as advertising screens, banners, billboards etc., where images may be erasable. An example of such an electrophotographic printing system that may enable printing and erasing of printed (non-fused) images may be seen with reference to U.S. application Ser. No. 10/745,596, entitled, “APPARATUS AND METHOD FOR RECYCLING TONER IN A PRINTED IMAGE DISPLAY SYSTEM”, by a common inventor, which is incorporated by reference in its entirety. In some embodiments suitable display systems may include a toner separation system, for separating the deleted toner into component colors, for example as described in embodiments in U.S. patent application Ser. No. 60/454,602, entitled, “A SYSTEM AND METHOD FOR COLOR TONER SEPARATION”, by a common inventor, which is incorporated by reference in its entirety. Alternatively or additionally, such display systems may include detachable printing devices which may be attached to a plurality of display systems to print wide format images, for example, as described in embodiments in U.S. patent application Ser. No. 10/784,214, by a common inventor, entitled, “SYSTEM, APPARATUS AND METHOD FOR PRINTING AND ERASING SCREEN-BASED IMAGES” which is incorporated by reference in its entirety.

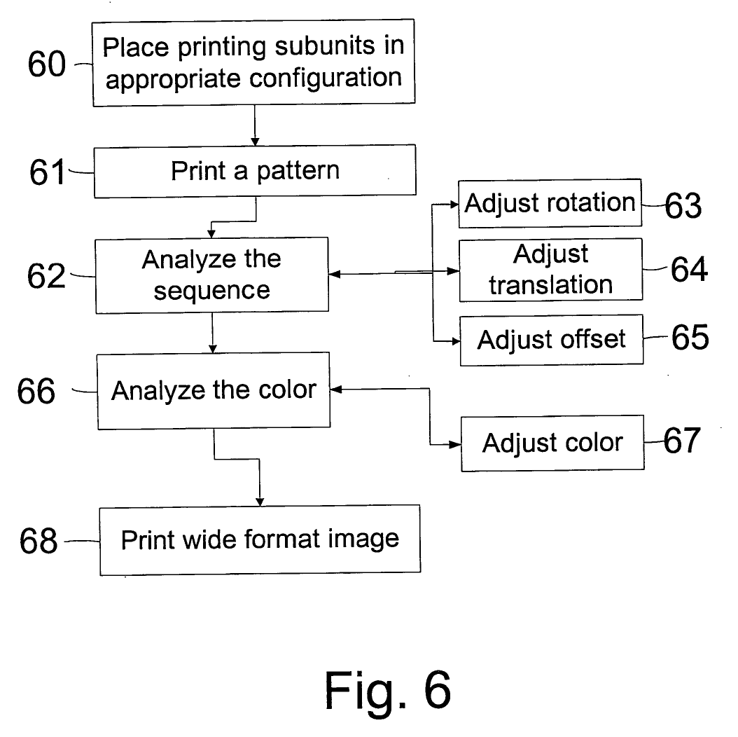

According to an embodiment of the present invention, a method is provided for printing onto wide format substrates. In some embodiments standard sized printing devices that are typically narrower than wide format substrates may be used. As can be seen with reference to FIG. 6, at block 60, the various printing sub-units are placed in an appropriate configuration. At block 61 a pattern may be printed on the substrate, by the various sub-units. For example, the pattern may include a set of lines, printed by the respective sub-units, that are required to form one or more continuous straight lines when the sub-units are properly tuned. Other patterns, sequences or alternative criteria for determining tuning of the sub-units may be used. At block 62, the pattern may be analyzed, for example, by an image capture component, for example a CCD and/or CMOS camera, or other suitable image processing means. Depending on the result of the sequence, the sub-units may be tuned or adjusted, mechanically and/or electronically. At blocks 63 and 64, this adjustment may require, for example, adjustment of the rotation (θ) and/or translation (X) for one or more printing sub-units. At block 65, in cases when an offset remains, the offset may be adjusted (Y)′. At block 66 the colors of printed images from the various printing sub-units may be analyzed, for example, by comparing samples of images printed out by the various sub-units. For example, images may be analyzed using a colorimeter or any other suitable tool or means, to determine similarity. At block 67, in cases where colors of one or more sub-units require adjustment, the colors of one or more sub-units may be adjusted. For example, one or more developers may be tuned, and optionally reprinted and retuned etc. to generate acceptable color matches between adjacent samples. At block 68 a wide format image may be printed. Any combination of the above steps may be implemented. Further, other operations or series of operations may be used.

While the present invention has been described with respect to electrophotographic printing technologies may be implemented in embodiments of the present invention. It will also be appreciated that any number of printing devices and device types may be integrated into the wide format printing system. Additionally it will be appreciated that the adjusting steps described above (for adjusting sub-units, offset and color etc.) may be implemented mechanically or electronically. In some embodiments printing systems having widths of less than 300 mm may be used.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A wide format printing system, the system comprising:
a wide format printing apparatus including a plurality of printing subunits being positioned to print across a wide format substrate; and
a printing controller to control the printing from said printing sub-units, to print an image across said wide format substrate,
wherein each of said printing from each of said printing sub-units prints an image narrower than said image printed across said wide format substrate.

2. The system of claim 1, comprising an image recognition unit.

3. The system of claim 2, wherein said image recognition unit includes a calorimeter.

4. The system of claim 2, wherein said image recognition unit includes a pattern recognition system.

5. The system of claim 1, wherein said printing controller is to enable analyzing of the output of said printing apparatus.

6. The system of claim 1, wherein said printing controller is to enable tuning of said printing sub-units

7. The system of claim 1, wherein said printing controller is to enable adjusting the color output.

8. The system of claim 1, comprising an erasing unit to erase non-fused toner images.

9. The system of claim 1, comprising a toner-recycling unit.

10. The system of claim 1, comprising color toner separation unit.

11. The system of claim 1, wherein said printing apparatus is detachable.

12. A wide format printing method, the method comprising:
placing a plurality of printing sub-units in an appropriate configuration in a wide format printing apparatus, said configuration to enable printing a wide format image across a wide format substrate, each of said plurality of printing sub-units printing an image narrower than said wide format image; and
printing a wide format image on said wide format substrate.

13. The method of claim 12, comprising:
printing a pattern on the substrate, by said sub-units; and
analyzing said pattern.

14. The method of claim 13, wherein if said pattern is not tuned, tuning at least one sub-unit.

15. The method of claim 14, wherein said tuning includes adjusting the rotation for at least one sub-unit.

16. The method of claim 14, wherein said tuning includes adjusting the translation for at least one sub-unit.

17. The method of claim 13, wherein if an offset remains after said printing by two or more said sub-units, adjusted the offset of at least one said sub-unit.

18. The method of claim 12, comprising:
printing samples of images by at least a subset of said subunits;
recognizing said samples; and
analyzing the colors of said samples.

19. The method of claim 18, wherein said recognizing is executed using an image recognition unit.

20. The method of claim 18, wherein said analyzing is executed using a printing controller.

21. The method of claim 18, comprising adjusting the color output of at least one sub-unit.

22. The system of claim 1, further comprising an eraser for erasing said image from said wide format substrate.

23. The method of claim 12, further comprising erasing said wide format image from side wide format substrate.
